(19) United States
(12) Patent Application Publication
(10) Pub. No.: US 2016/0113443 A1
(43) Pub. Date: Apr. 28, 2016

(54) ELECTRIC EJECTION BREAD TOASTER

(71) Applicants: Sean De Jager, Rehoboth (NA); Anthony De Jager, Rehoboth (NA)

(72) Inventors: Sean De Jager, Rehoboth (NA); Anthony De Jager, Rehoboth (NA)

(21) Appl. No.: 14/986,610

(22) Filed: Dec. 31, 2015

Related U.S. Application Data
(60) Provisional application No. 62/252,430, filed on Nov. 7, 2015.

(51) Int. Cl. A47J 37/08

(52) U.S. Cl. CPC A47J 37/0842

(57) ABSTRACT

The embodiments herein relate to an electric ejection bread toaster. The electric ejection bread toaster comprises a toaster body having a base portion and at least one slot at an opposite top portion. A plurality of heating elements within the body for toasting a bread product is provided. A bread supporting assembly is provided. The bread supporting assembly has side guides and a moveable base member. The base member is being slidably moveable between the side guides from a lower retracted toasting condition to a raised ejecting condition for operatively ejecting a toasted bread product out of the slot onto a predetermined distance from the toaster. The bread supporting assembly is tilted from a horizontal plane such that, in use, the toasted bread product is ejected out through the slot onto a plate kept alongside the toaster body and to a lateral side of the toaster body.

### BACKGROUND

1. Technical Field of Invention

The embodiments herein generally relate to electric toasters, and particularly to “pop-up” toasters. The embodiments herein more particularly relate to pop-up toasters wherein a bread is raised above the toaster after toasting and ejects completely and falls off at a predetermined distance from the toaster.

2. Description of Related Art

Electric toasters, or so-called “pop-up toasters” are well known household appliances which are used on a regular basis for toasting a variety of bread products. Such toasters are normally equipped with electromechanical means that act to raise a slice of toasted bread and switch off the toaster once a toasting operation has been completed.

In general, bread slices or other articles to be toasted are inserted vertically into slots at the top of the toaster, into a bread support comprising side guides, for holding a slice of bread upright, and a moveable supporting base, which is movable by a lever, on one side of the toaster, for raising and lowering the bread between the guides. The guides are surrounded by heating elements for heating both sides of the bread simultaneously.

Once the toasting operation is completed, a timer or other sensing device is used to automatically turn off electrical power to the heating elements. At the same time the lever is moved to lift the bread support and thereby lift the toast above the height of the toaster so that it may be manually removed for consumption.

If the bread is too small, then even after ejection, or “popping” of the bread support, it is difficult to access the toasted bread as it does not project above the height of the toaster. Also, as the bread is not totally ejected at the end of the toasting operation, there is a risk that a fire could be caused, for example, if the electrical supply to the heating elements is not switched off; the heating elements continue to heat and then char and possibly ignite the bread with the production of a flame, which could spread to flammable material in the proximity of the toaster.

Hence there is a need to develop a toaster which alleviates the above mentioned problems and also give advantages of automatically and timely ejection of the toast and falling off from the toaster slots to a predetermined distance away from the toaster.

The above mentioned shortcomings, disadvantages and problems are addressed herein, as detailed below.

### SUMMARY OF THE INVENTION

The primary object of the embodiments herein is to provide an electric toaster wherein the base portion is raised and tilted up to a certain extend enabling the toast to eject out completely and fall off at a predetermined distance from the toaster body.

Another object of the embodiments herein is to provide an electric toaster that automatically cuts off the current after the bread is toasted.

Yet another object of the embodiments herein is to provide an electric toaster having a stronger spring that enables a toast to fall off at a predetermined distance from the toaster bread following a projectile path.

Yet another object of the embodiments herein is to provide an electric toaster enabling an equal toasting of bread from all directions.

According to an embodiment herein, an electric ejection bread toaster is provided. The electric ejection bread toaster comprises a toaster body having a base portion and at least one slot at an opposite top portion. A plurality of heating elements within the body for toasting a bread product is provided. A bread supporting assembly is provided. The bread supporting assembly has side guides and a moveable base member. The base member is being slidably moveable between the side guides from a lower retracted toasting condition for operatively positioning the bread product between the heating elements to a raised ejecting condition for operatively ejecting a toasted bread product out of the slot onto a predetermined distance from the toaster. The ejector means for moving the base member from a retracted condition to an ejecting condition is provided and the bread supporting assembly is tilted from a horizontal plane such that, in use, the toasted bread product is ejected out through the slot onto a plate kept alongside the toaster body and to a lateral side of the toaster body.

According to an embodiment herein, the base portion of the toaster body has a greater height on a rear side thereof for tilting the bread supporting assembly.

According to an embodiment herein, the base portion includes a foot arrangement for increasing the height on a rear side thereof.

According to an embodiment herein, the ejection means includes a trip lever which is upwardly spring loaded for moving the base member and is depressed against a spring load for lowering the base member to the retracted toasting condition.

According to an embodiment herein, the electric toaster further comprises an electrical power switch arranged to supply power to the heating elements.

According to an embodiment herein, the electrical power switch is closed when the base member is in a lower retracted toasting condition and opened when the base member is moved to a raised ejecting condition.

According to an embodiment herein, the heating elements are positioned closer to the one side of the bread supporting assembly than the other so that, in use, a bread product receives an even toasting even though it is resting at a tilted angle on the one side of the bread supporting assembly.

According to an embodiment herein, the electric toaster further comprises an adjustable timer for timing a toasting operation.

According to an embodiment herein, the timer is activated when the base member is moved to the retracted toasting condition, and after a pre-selected time, the timer activates the ejector means for moving the base member to its ejecting condition.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a perspective view of an electric ejection bread toaster showing a slice of toast being ejected out and falling on a plate, according to an embodiment herein.

FIG. 2 is a rear view of an electric ejection bread toaster, according to an embodiment herein.

FIG. 3 is a side view of an electric ejection bread toaster, according to an embodiment herein.

FIG. 4 is a side sectional view of an electric ejection bread toaster showing an ejection mechanism comprising a trip lever and a timing lever, according to an embodiment herein.

FIG. 5 is rear sectional view of an electric ejection bread toaster showing an adjustable stop arm and a gravity catch device, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide an electric toaster that ejects toasted products laterally out of the toaster body. The toaster comprises a toaster body with a tilted base portion, for example with a foot arrangement, having a greater height on a rear side thereof for tilting a bread supporting assembly within the toaster. Also included is an upwardly spring loaded trip lever which is depressed against its spring load for lowering a bread into the toaster. A plurality of heating elements present within the body to toast the bread for a preselected time and the bread is then ejected vertically and transversely out of the toaster to a rear side thereof, at a predetermined distance from the toaster body.

According to an embodiment herein, an electric toaster is provided. The electric toaster comprises a toaster body. The toaster body has a base portion and at least one slot at an opposite top portion. The toaster body further comprises a plurality of heating elements within the body for toasting a bread product. A bread supporting assembly is provided that comprises side guides and a base member, for supporting the bread product. The base member is slidably moveable between the guides from a lower retracted toasting condition, for operatively positioning the bread product between the heating elements, to a raised ejecting condition, for operatively ejecting a toasted bread product out of the slot onto a plate kept alongside the toaster at a predetermined distance from the toaster. The ejector means for moving the base member from its retracted condition to its ejecting condition is provided.

According to an embodiment herein, the bread supporting assembly is tilted from a horizontal plane such that, in use, the toasted bread product is ejected out through the slot onto a plate kept alongside the toaster and to a lateral side of the toaster body, at a predetermined distance from the toaster body. The predetermined distance is at least 3 cm away from the toaster body.

According to another embodiment herein, the base portion of the toaster body has a greater height on a rear side thereof in order to tilt the bread supporting assembly and to provide a foot arrangement at the base portion for increasing the height on a rear side thereof of the toaster body.

According to an embodiment herein, an ejection means is provided. The ejection means comprises a trip lever which is upwardly spring loaded for moving the base member and is depressed against the spring tension for lowering the base member to its retracted toasting condition; and for the lever to be spring loaded.

According to another embodiment herein, the toaster comprises an electrical power switch arranged to supply power to the heating elements. The electrical power switch is closed when the base member is in its lower retracted toasting condition and opened when the base member is moved to its raised ejecting condition. The heating elements are positioned closer to the one side of the bread supporting assembly than the other side so that a bread product receives an even toasting even though it is resting at a tilted angle on the one side of the bread supporting assembly.

According to an embodiment herein, the toaster comprises an adjustable timer for timing a toasting operation. The timer is activated when the base member is moved to its lower retracted condition. After a pre-selected time, the timer activates the ejector means for moving the base member to its ejecting condition.

In accordance with the present specification, the terms ‘bread’ and ‘bread product’ will be understood to include any consumable products which may be toasted for consumption such as, for example, slices of bread, bagels, etc.

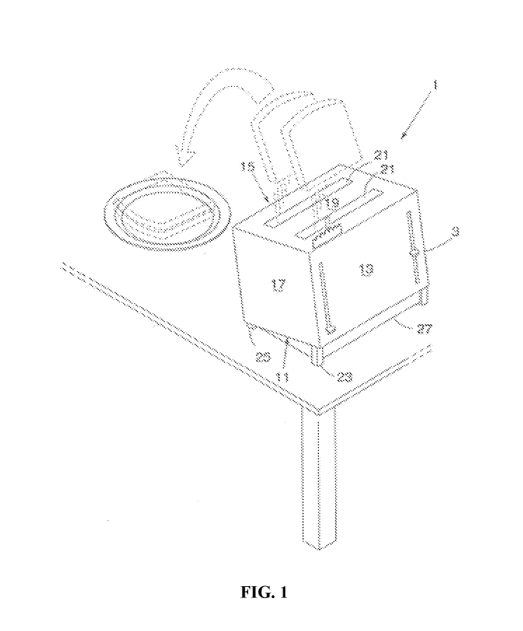

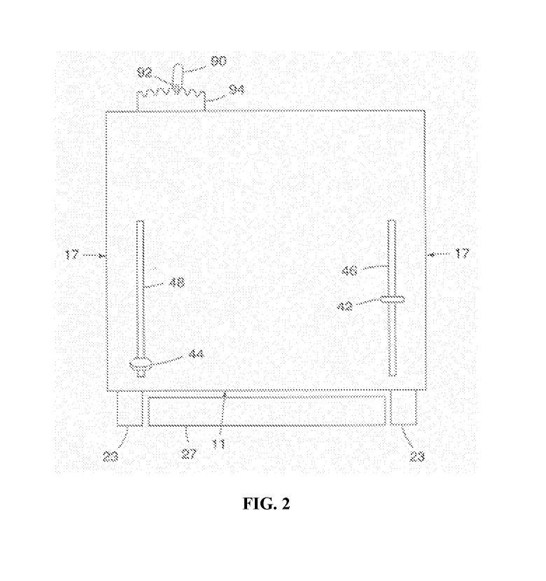

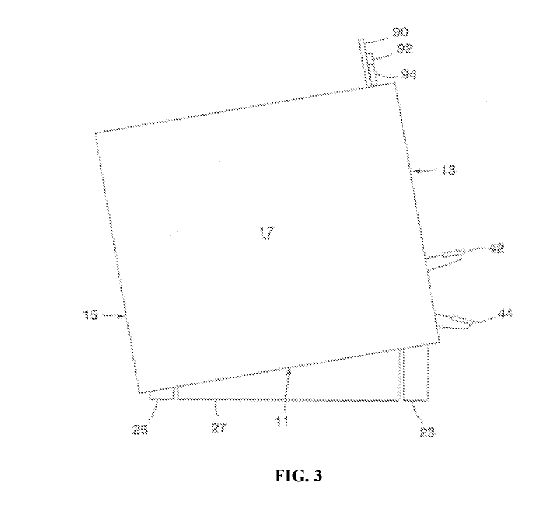

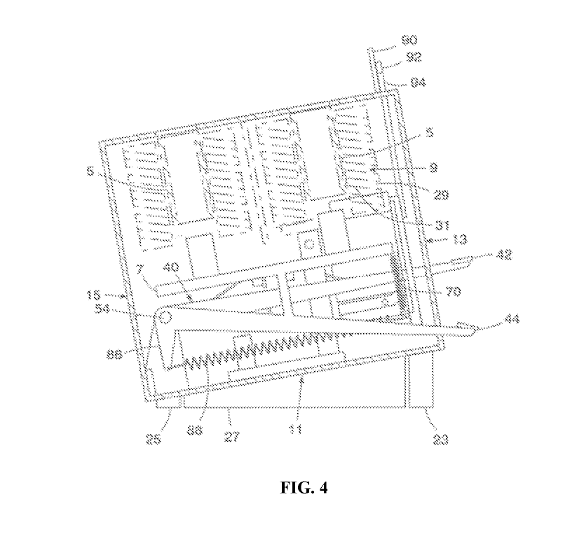

According to a preferred embodiment of the invention, and with respect to FIG. 1 to FIG. 5, an electric toaster 1 is provided. Electric toaster 1 has a toaster body 3 that forms a housing around a bread supporting assembly 5. Side guides and a moveable base member 7, and heating elements 9 for toasting bread products are also provided.

The toaster body 3 has a rectangular base 11 with a rear wall 13, front wall 15 and two side walls 17 extending upwardly therefrom towards a top surface 19. The top surface 19 is provided with two slots 21 along the length thereof for receiving a bread product to be toasted.

The rectangular base 11 of the toaster body 3 is provided with two rear feet 23, located below the rear wall 13 and two front feet 25 located below the front wall 15. The rear feet 23 are longer than the front feet 25, resulting in the toaster body 3 being tilted from its vertical plane or horizontal plane from the base. Due to this tilted set up, the bread supporting assembly 5 within the toaster body is also tilted from the vertical plane; and as a result causes the trajectory of a toasted bread product being ejected from the toaster body 3 to be in a vertical and transverse direction and towards the front side of the toaster, on the side of the front wall 15.

A removable crumb tray 27 is positioned below the toaster body 3 to collect falling crumbs from toasting bread product.

The bread supporting assembly 5 is an open framework wire structure with side guides, for supporting a bread product, and the moveable base member 7 which is slidably moveable between the guides from a lower retracted toasting condition, for operatively positioning the bread product between the heating elements 9, to a raised ejecting condition, for operatively ejecting a toasted bread product out of the slot 21. The open spaces between the side guides of the bread supporting assembly 5 allow exposure of a bread product placed therein to the surrounding heating elements 9, when the base member 7 is moved to its lower retracted toasting condition.

The heating elements 9 consist of mica sheets 29 with heating wires 31 wrapped helically around the mica sheets, with their convolutions spaced from each other. The mica sheets 29 are positioned within the toaster body 3 such that they are on either side of the bread supporting assembly 5. The heating elements 9 are positioned closer to the one side of the bread supporting assembly (in this embodiment, the top side, closer to the rear wall 13) than the other (on the side of the front wall 15), so that the bread receives an even toasting even though it is resting at a tilted angle on the one side of the assembly. The heating elements 9 operate in the conventional manner, used in well-known toasters available in the market place.

The ejector means 40 located in the toaster body 3 below the base member 7 comprise a timing lever 42 and a trip lever 44. The timing lever 42 is moveable up and down in a first vertical slot 46 in the rear wall 13 of the toaster body 3 and the trip lever 44 is moveable in a second vertical slot 48 in the rear wall of the toaster body.

The timing lever 42 is connected to a timing device 80 which, in this embodiment, includes a clockwork mechanism mounted in a box. The clock mechanism is of any standard construction known in the art. A cylindrical member 82 of the clock mechanism is secured to one end of a chain 84 and the other end of the chain is secured to the timing lever 42 pivoted at its rear end near the front wall 15 to a rod 54. Depression of the timing lever 42, pulls the chain 84 to wind up a spring of the clock mechanism in the timing device 80.

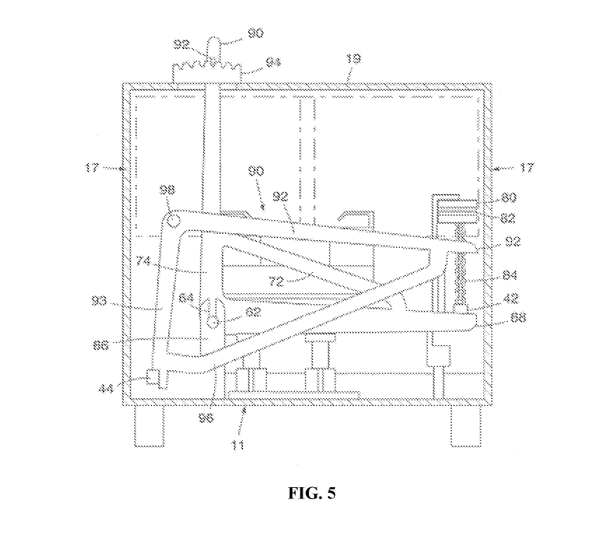

An adjustable stop arm 68 is provided towards the base 11 of the toaster body 3, for stopping the movement of the timing arm 42. The opposite end of the stop arm 68 is pivoted 62 and is secured to an upwardly extending arm 74. The stop arm 68 and upwardly extending arm 74 are secured by a brace arm 72. The pivot 62 is mounted to a vertical slot 64 formed in a member 66 extending from the base 11 of the toaster body 3. The pivot 62 is urged into a downward position in this slot 64 by a coiled spring 70 attached at its upper end to the upwardly extending arm 74 and attached to the member 66 at its lower end. The upper end of the upwardly extending arm 74 terminates in a handle portion 90 which carries a detent 92 adapted to be engaged in any one of a number of notches formed in the upper edge of an angular member 94 secured on the top surface 19 of the toaster body 3. The horizontal portion of the angular member 94 bears numbers corresponding to different notches. On lifting the handle portion 90, the detent 92 is moved from its notch, whereupon the handle portion 90 may be moved towards the right or left and the detent 92 and may then be engaged in any desired notch. As the handle is moved towards the right, as viewed in FIG. 5, the stop arm 68 is depressed and hence the timing period is increased since the timing lever 42 is depressed to a greater extent.

The trip lever 44 is also pivoted at its rear end near the front wall 15 on the rod 54 at which place it is provided with a downwardly extending arm 86. The downwardly extending arm 86 is connected by a coiled spring 88 to the rear wall 13 of the toaster body 3 so that the trip lever 44 is normally spring loaded into an upward position. The trip lever 44 is connected to the moveable base member 7, and manually moves the base member 7 down to its retracted condition when the trip lever 44 is depressed, or raises the base member 7 upwardly to its ejecting condition when the trip lever 44 is pulled up by the coiled spring 88.

When the trip lever 44 is pulled down as far as it goes against the tension of the spring 88, it is engaged by a triangular shaped gravity catch device 90. The catch device 90 has three members, forming an upper member 92, side member 93 and lateral member 96 of a triangle, and is pivoted 98 to the toaster body 3 towards the side wall 17, so as to normally swing towards the left, as viewed in FIG. 5. The lower end of the lateral member 96 engages and holds down the top of the trip lever 44 when the trip lever has been pulled down against its upward spring loaded position.

In use, slices of bread are placed in the bread supporting assembly 5, through the slots 21 at the top of the toaster body 3, and lie between the side guides of the bread supporting assembly 5, and on the base member 7. The trip lever 44 is depressed to its retracted condition to lower the bread into the toaster body and between the heating elements 9. The timing lever 42 is depressed at the same time or just prior to the depression of the trip lever 44.

When the trip lever 44 is depressed, an electrical power switch arranged to supply power to the heating elements 9 is closed and the heating elements begin toasting the bread product.

The timing lever 42, when depressed, pulls the chain 84 and winds up the spring of the clock mechanism of the timing device 80. The timing lever 42 is moved down until its strikes one end of the adjustable stop arm 68. As the chain 84 is wound up, the timing lever moves upwardly until strikes the bottom of the upper member 92 of the triangular catch device 60. Lifting of the upper member 92 causes the catch device 90 to pivot to the right, as viewed in FIG. 5, and this movement releases the upwardly spring loaded trip lever 44, which is quickly pulled up by the spring 88, raising the base member 7 upwardly. Due to the tension of the spring 88, this rapid movement of the base member 7 causes the toasted bread within the bread supporting assembly 5 to be ejected upwardly and laterally out of the toaster body 3 onto the side of the front wall 15, onto a plate on alongside the toaster body. The plate must be at least 3 cm away from the toaster body. At the same time, when the trip lever 44 is pulled up, the electrical power switch arranged to supply power to the heating elements 9 is opened and the heating elements turned off.

According to the embodiments herein, the toast after the toasting is completed rises not only to the surface of the toaster but also completely gets ejected out of the toaster onto a counter or plate placed at a predetermined distance of at least 3 cm. The entire toaster including all the working mechanisms within the toaster are set at an angle enabling the toasted bread to land on the counter/plate beside the toaster.

According to an embodiment herein, the angle is below 90 degrees, preferable the angle is below 90 degrees large enough to give sufficient tilt to cause adequate ejection of the toasted bread. The angle is preferably between 10 degrees to 75 degrees.

The electric toaster of the present invention is aimed at an oblique movement of the toasted bread and enabling the toast to be ejected onto a counter or plate placed beside the toaster body.

According to an embodiment herein, a resting grid supporting the lower side of the leaning bread is placed slightly further from the lower heating elements in both slots allowing the bread to be situated equidistant from the two heating elements thus enabling the bread to be toasted evenly dark on both sides.

According to the embodiments herein, the electric toaster is provided that ejects four or more slices of toasts.

According to the embodiments herein, the ejecting mechanism is capable of providing a sufficient force to cause rapid upward movement of the base member. The configuration of the bread supporting assembly and heating elements are modified to accommodate more or differently sized bread products. The foot arrangement is adjustable to adjust the tilt of the toaster and the timing mechanism and power supply is adapted to any conventional type known in the art.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

We claim:

1. An electric ejection bread toaster comprises:
a toaster body having a base portion and at least one slot at an opposite top portion; a plurality of heating elements within the body for toasting a bread product;
a bread supporting assembly, wherein the bread supporting assembly has side guides and a moveable base member, the base member being slidably moveable between the side guides from a lower retracted toasting condition for operatively positioning the bread product between the heating elements to a raised ejecting condition for operatively ejecting a toasted bread product out of the slot onto a predetermined distance from the toaster, and
ejector means for moving the base member from a retracted condition to an ejecting condition;
wherein the bread supporting assembly is tilted from a horizontal plane at an angle such that, in use, the toasted bread product is ejected out through the slot onto a plate kept alongside the toaster body and to a lateral side of the toaster body.

2. The electric toaster according to claim 1, wherein the base portion of the toaster body has a greater height on a rear side thereof for tilting the bread supporting assembly.

3. The electric toaster according to claim 1, wherein the base portion includes a foot arrangement for increasing the height on a rear side thereof.

4. The electric toaster according to claim 1, wherein the ejection means includes a trip lever which is upwardly spring loaded for moving the base member and is depressed against a spring load for lowering the base member to the retracted toasting condition.

5. The electric toaster according to claim 1, wherein the electric toaster further comprises an electrical power switch arranged to supply power to the heating elements.

6. The electric toaster according to claim 5, wherein the electrical power switch is closed when the base member is in a lower retracted toasting condition and opened when the base member is moved to a raised ejecting condition.

7. The electric toaster according to claim 1, wherein the heating elements are positioned closer to the one side of the bread supporting assembly than the other so that, in use, a bread product receives an even toasting even though it is resting at a tilted angle on the one side of the bread supporting assembly.

8. The electric toaster according to claim 1, wherein the electric toaster further comprises an adjustable timer for timing a toasting operation.

9. The electric toaster according to claim 8, wherein the timer is activated when the base member is moved to the retracted toasting condition, and after a pre-selected time, the timer activates the ejector means for moving the base member to its ejecting condition.

10. The electric toaster according to claim 1, wherein the angle is below 90 degrees, preferably between 10 degrees to 75 degrees.
